(19) United States
(12) Patent Application Publication
(10) Pub. No.: US 2013/0174399 A1
(43) Pub. Date: Jul. 11, 2013

(54) Removable Forming Support

(71) Applicant: Bernie Goldfuss, Hot Springs, AR (US)

(72) Inventor: Bernie Goldfuss, Hot Springs, AR (US)

(21) Appl. No.: 13/346,605

(22) Filed: Jan. 9, 2012

(51) Int. Cl. F16B 7/18; B23P 11/00

(52) U.S. Cl. 29/428; 403/343

(57) ABSTRACT

A removable forming support comprising a tapered sleeve having a first, internally threaded end and a second end that has a smaller outside diameter than does the first end. A threaded tie rod is threadedly received in the first end of the tapered sleeve, while a further tie rod can optionally be threaded into the second end of the tapered sleeve, which then also is internally threaded. The tie rod or rods are secured in position in the ends of the tapered sleeve.

### BACKGROUND OF THE INVENTION

The present invention relates to a removable forming support, a sleeve for such a removable forming support, and a method of producing such a removable forming support.

It is an object of the present application to provide an improved tie-rod assembly.

### BRIEF DESCRIPTION OF THE DRAWINGS

This object, and other objects and advantages of the present application, will appear more clearly from the following description in conjunction with the accompanying schematic drawings, in which:

FIG. 1 shows one exemplary embodiment of a removable forming support of the present application;

FIG. 2 illustrates the threads of the sleeve of the removable forming support of FIG. 1;

FIG. 3 is an enlarged view of the encircled region of FIGS. 1 and 5;

FIG. 4 shows the punching of a sleeve to attach the sleeve to a tie rod;

FIG. 5 shows a further tie rod threaded into the removable forming support of FIG. 1;

FIG. 6 shows the stop of the sleeve;

FIG. 7 shows a second exemplary embodiment of a removable forming support of the present application; and

FIG. 8 is an enlarged view of the narrow end of the sleeve of the removable forming support of FIG. 7.

### SUMMARY OF THE INVENTION

The removable forming support of the present application comprises a tapered sleeve having a first, internally threaded end and a second end, with the second end having a smaller outer diameter than does the first end; a threaded tie rod that is configured to be threadedly received in the first end of the tapered sleeve; and means, expediently formed by a punched or pressed portion of the tapered sleeve that internally forms a projection that extends between threads of the tie rod, for securing the tie rod in position in the first end of the tapered sleeve.

A further aspect of the present application relates to a sleeve for use in such a removable forming support, with such a sleeve comprising a round, tapered member having a first internally threaded end and a second end, wherein the second end has a smaller outer diameter than does the first end, further wherein the first, threaded end of the tapered member is configured to threadedly receive a threaded tie rod, and wherein when a threaded tie rod is threadedly received in the first end of the tapered member, the tapered member is configured to secure the tie rod in position in the first, threaded end.

Pursuant to another aspect of the present application, a method is provided for producing a removable forming support, and includes the steps of providing a tapered member; internally threading at least a first end of the tapered member, wherein such first end has a greater outer diameter than does an opposite, second end of the tapered member; threading a tie rod into the first end of the tapered member; and securing the tie rod in position in the internally threaded first end of the tapered member.

Further specific features of the present invention will be described in detail subsequently.

### DESCRIPTION OF SPECIFIC EMBODIMENTS

Referring now to the drawings in detail, shown are exemplary embodiments of removable forming supports of the present application, which are designated generally by the reference 10.

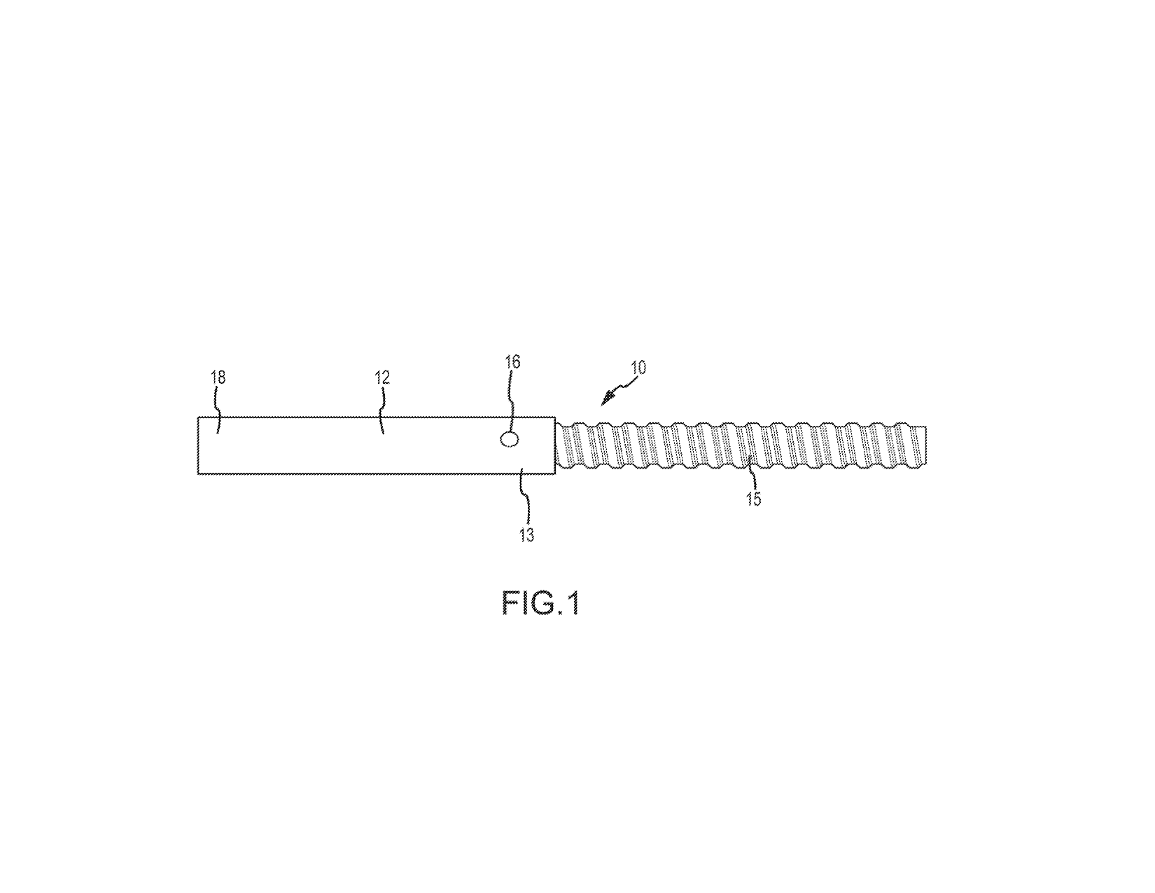

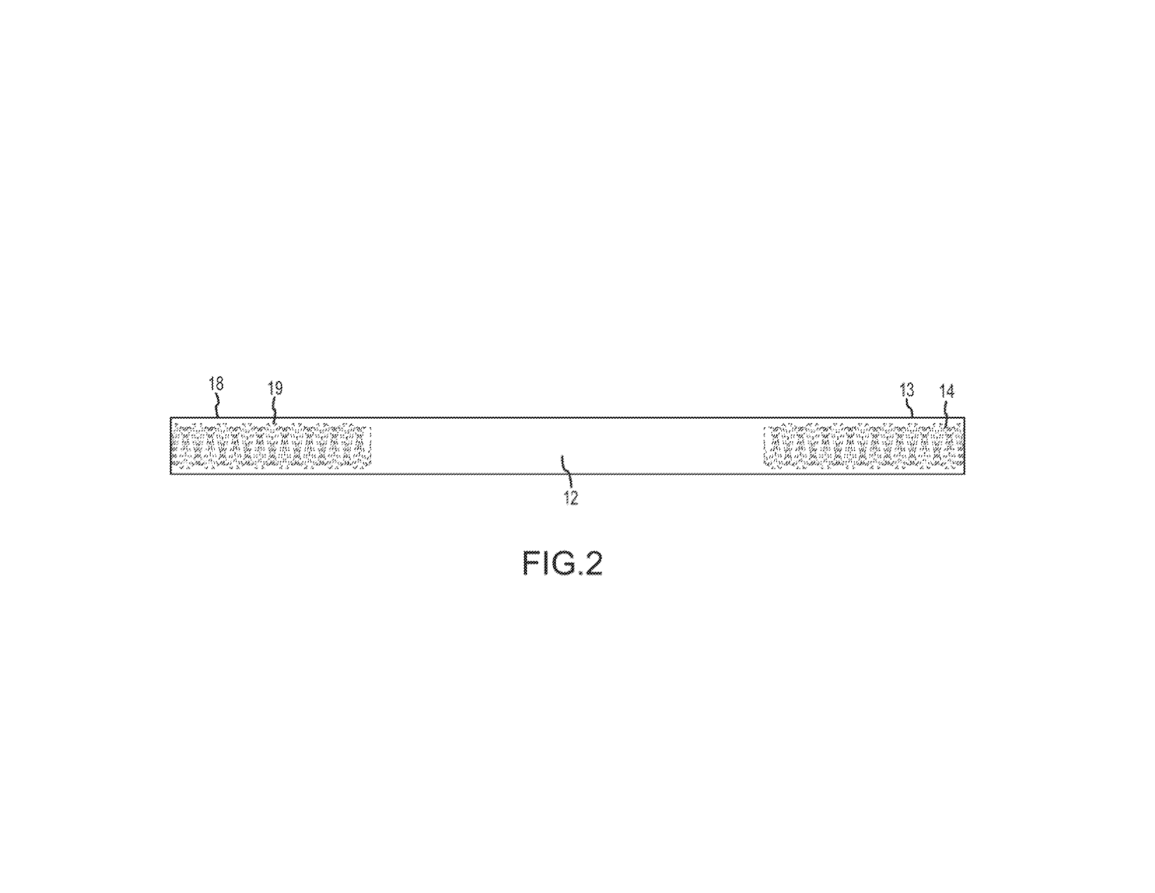

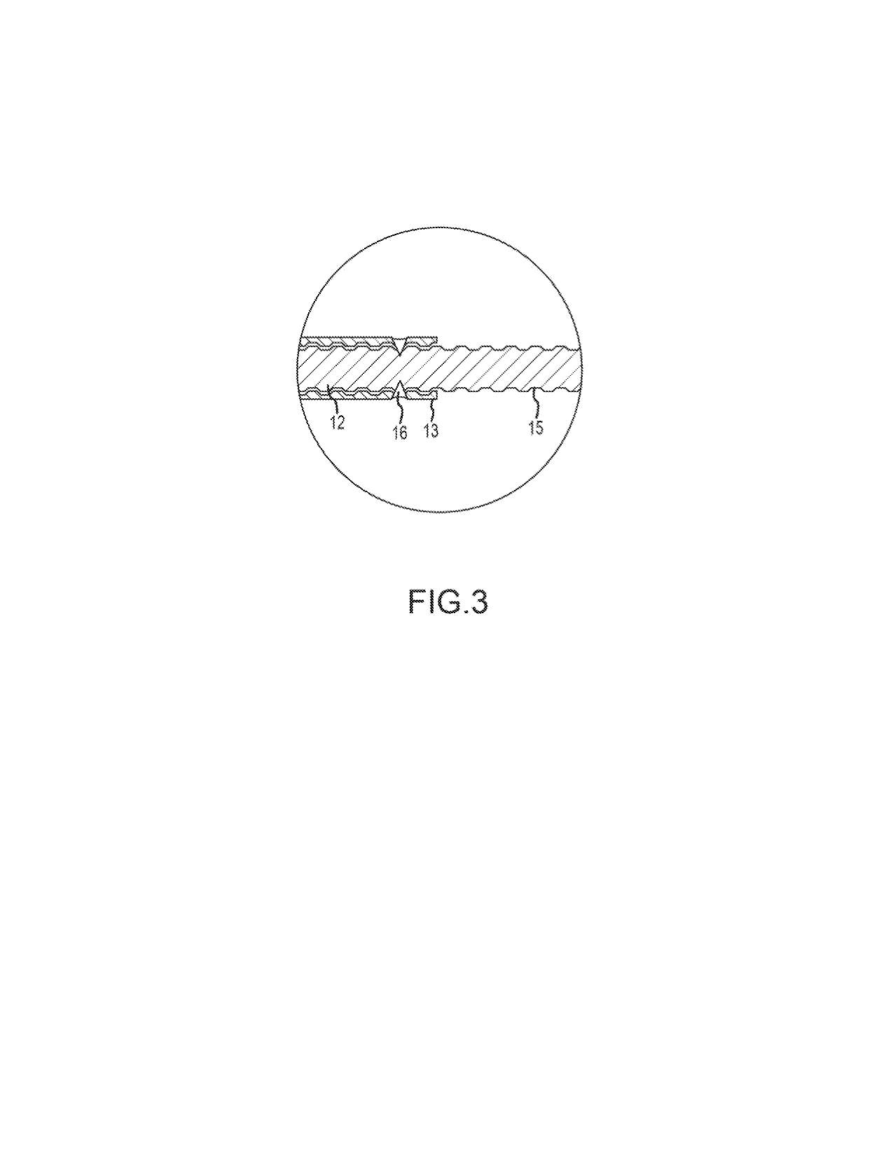

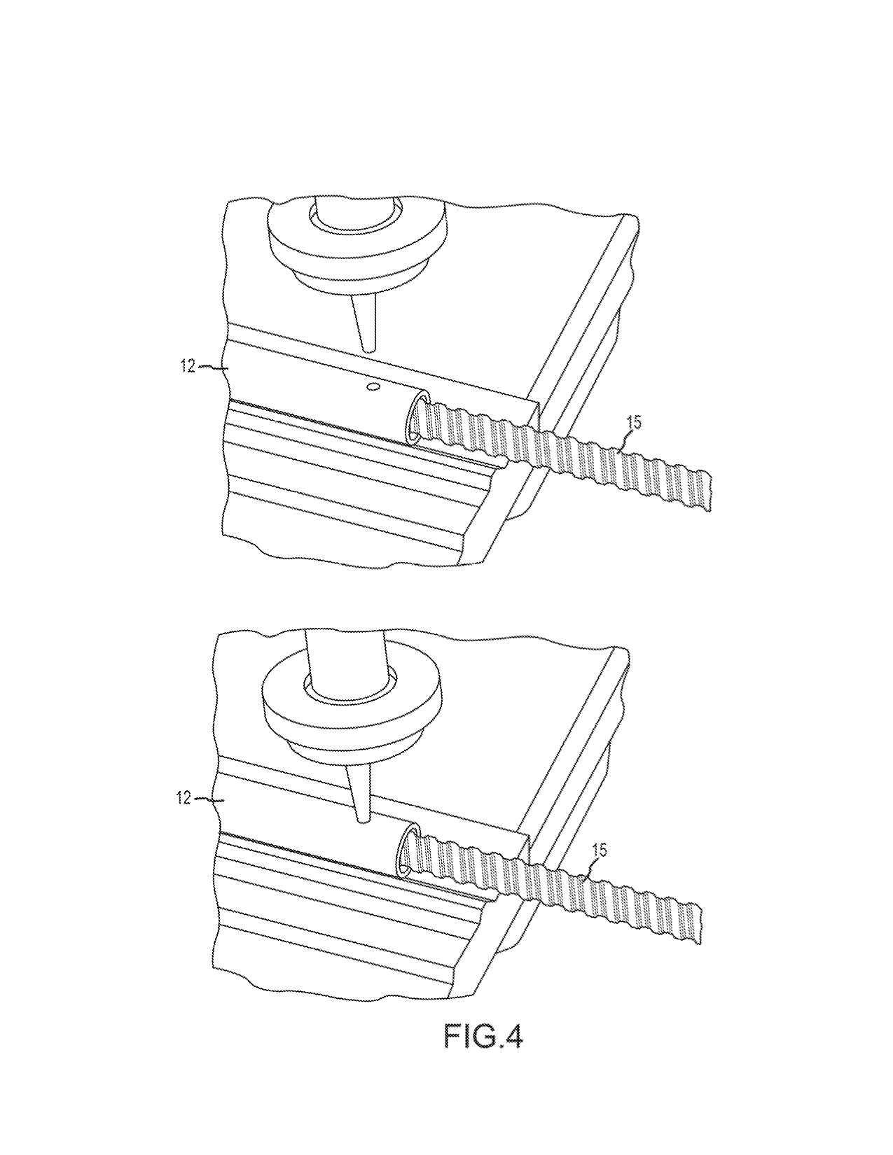

The forming support 10 of FIG. 1, also known as a she-bolt, comprises a sleeve 12, which is tapered for reasons to be discussed in detail below. At least the end 13 of the tapered sleeve 12, which end 13 has the greater outer diameter, is provided with an internal thread 14 (see e.g. FIGS. 2 and 3). A threaded tie rod 15 is threaded into the internal thread 14 of the tapered sleeve 12, and is secured in position, as shown particularly clearly in FIG. 3. In the illustrated embodiment, this connection or securement is effected by a swaging, stamping, or punching of the tapered sleeve 12. In particular, as shown in FIG. 4, a so-called conical press can be applied to the tapered sleeve 12 after the tie rod 15 is threaded therein in order to stamp, punch or otherwise press a portion of the sleeve wall onto the outer surface of the tie rod 15, and in particular between threads thereof. Further punching can also be effected, with the punchings being uniformly distributed about the periphery of the tapered sleeve 12. By way of example only, two such punchings are shown in FIG. 3 and are disposed 180° apart.

The inventive forming support 10 can be used with the configuration already described, with the sleeve 12 thereof being used as a spacer between two members, such as concrete-retaining members, with concrete then being poured into the space between the retaining members to form a wall. It should be noted that the depression 16 formed in the sleeve 12 by the punching process should not be disposed within the space between the retaining members since doing so would allow concrete to enter the depression 16 and could make removal of the forming support 10 from the poured concrete wall more difficult.

At the conclusion of the concrete-pouring process, the sleeve 12, together with the tie rod 15 secured thereto, can be removed from the poured concrete wall. The removal of the tie rod 15 and attached sleeve 12 is effected by rotating the threaded tie rod 15 with an appropriate tool. Since the tie rod 15 is secured to the sleeve 12, the sleeve 12 will also rotate. As the threaded tie rod 15 is threaded out of its retaining member, the sleeve 12 will easily follow along without any undue resistance due to the tapered nature of the sleeve 12, which becomes narrower in a direction away from the direction of removal. After the tie rod 15 has been threaded out of its retaining member, the removal process can be completed by pulling on the tie rod 15, or on the sleeve 12 once the end 13 thereof is exposed.

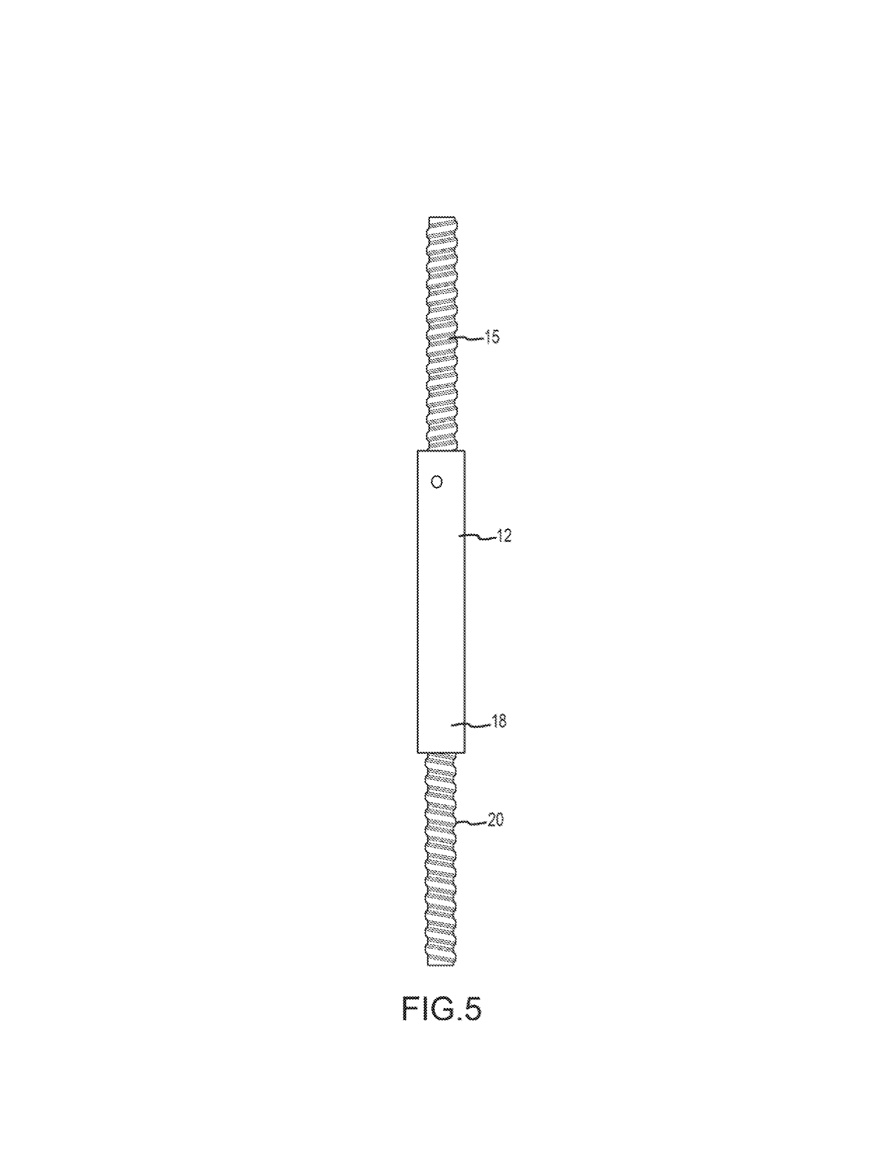

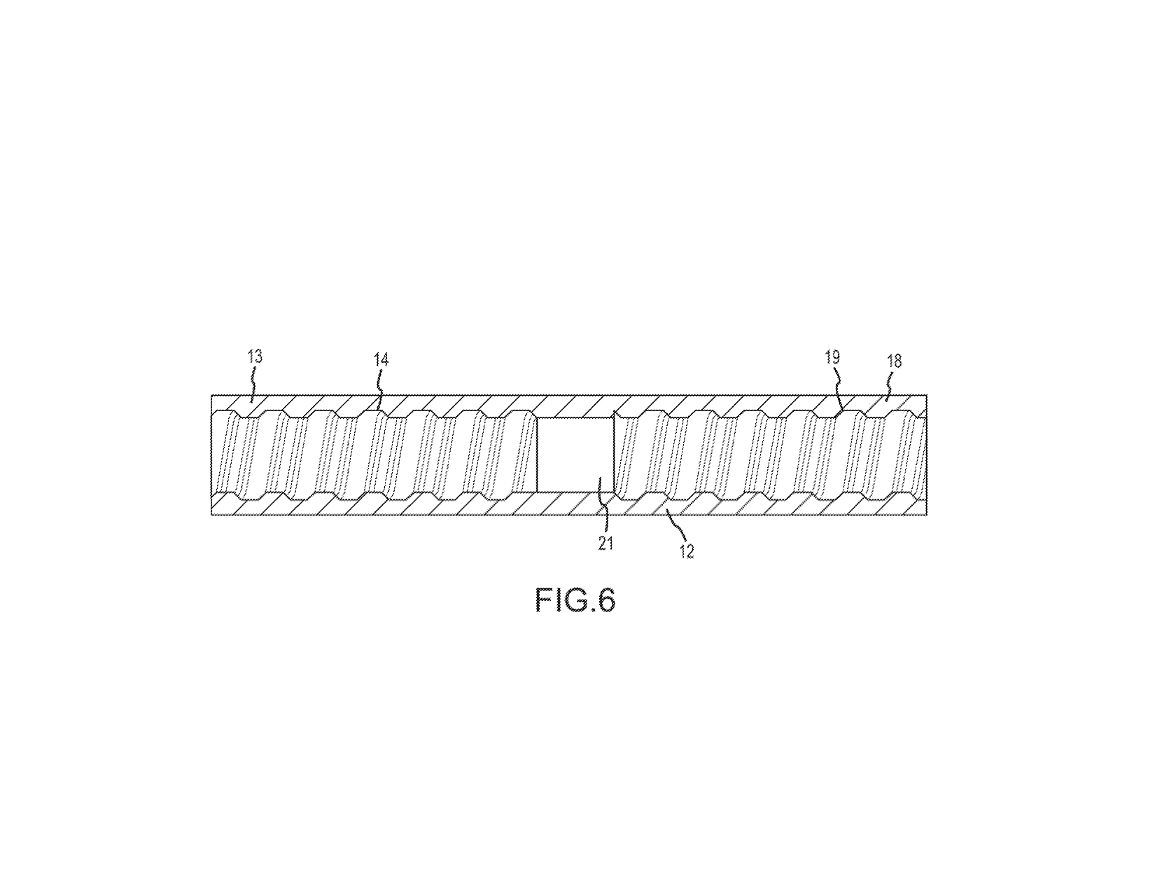

For thicker walls, in other words wider spaces or distances between the retaining members, the other, smaller diameter end 18 of the sleeve 12 can also be provided with an internal thread 19 (FIG. 2) for receiving a further tie rod 20, as shown in FIG. 5. In this embodiment, the further tie rod 20 is not secured to the sleeve 12. It should also be noted that the sleeve 12 is expediently solid in the center between its internal threads 14 and 19 to form a stop 21 for the tie rods 15 and 20 as they are threaded into their respective internal threads 14 and 19 (see FIG. 6). At least portions of both of the tie rods 15 and 20 can extend through and beyond the retaining members for appropriate securement to the retaining members, as is known to those of ordinary skill in the industry.

At the conclusion of the concrete-pouring process, the sleeve 12, with the tie rod 15 secured thereto, can be removed, leaving the further tie rod 20 in place in the poured concrete wall. The removal of the tie rod 15 and attached sleeve 12 is effected by rotating the threaded tie rod 15 with an appropriate tool. Since the tie rod 15 is secured to the sleeve 12, the sleeve will also rotate, and will unthread from the father tie rod 20. As the threaded tie rod 15 is threaded out of its retaining member, the sleeve 12 will easily follow along without any undue resistance due to the tapered nature of the sleeve 12, which becomes narrower in a direction away from the direction of removal.

To facilitate the removal process, if a portion of the further tie rod 20 extends out of its retaining member and is accessible, it can be tapped or hammered upon to start the process of loosening of the forming support 10, and in particular the sleeve 12 thereof, from the poured concrete wall. After the tie rod 15 has been threaded out of its retaining member, the removal process can be completed by pulling on the tie rod 15, or on the sleeve 12 once the end 13 thereof is exposed.

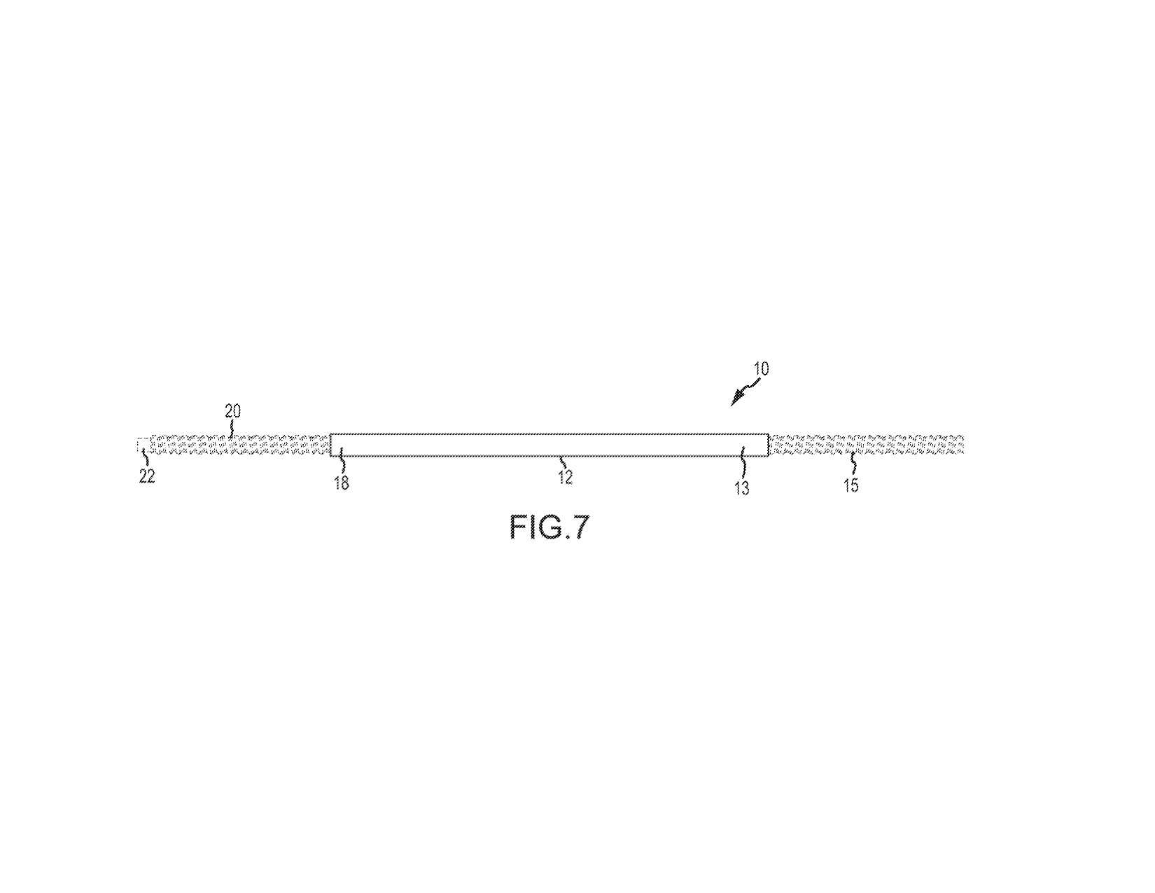

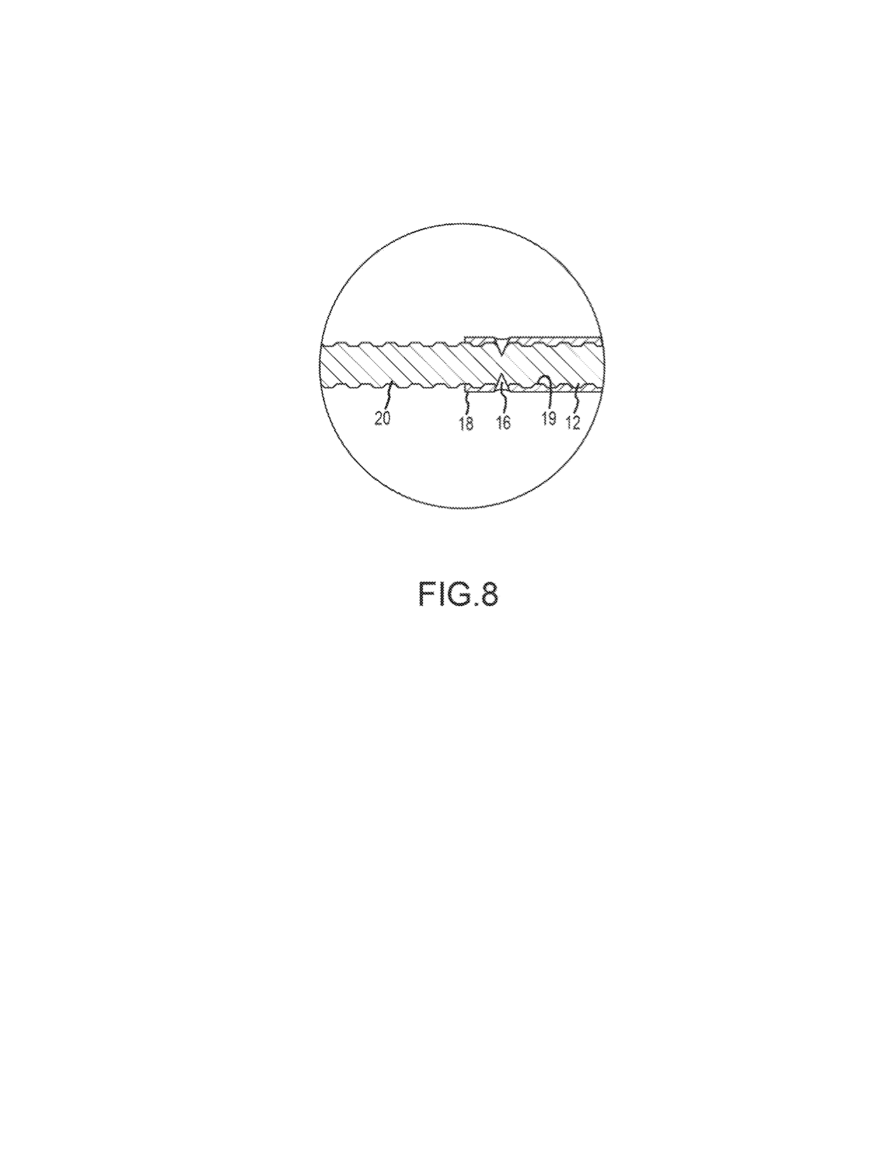

For even thicker walls that are to be poured, the forming support of the present application can take the form of a so-called taper tie. Such an embodiment is illustrated in FIG. 7. The forming support 10 illustrated in FIG. 7 again comprises a tapered sleeve 12, with both of the ends 13 and 18 thereof being provided with internal threads 14 and 19 respectively, as shown for example in FIGS. 3 and 8. Two threaded tie rods 15 and 20 are threaded into their respective internal threads 14 and 19 of the tapered sleeve 12. In the manner described in conjunction with the she-bolt embodiment, after the tie rods 15 and 20 are threaded into the tapered sleeve 12, a conical press is applied to both ends 13 and 18 of the sleeve 12 to stamp or punch portions of the sleeve wall onto the outer surfaces of the tie rods 15 and 20, i.e. between threads of the tie rods, to secure the tie rods 15 and 20 in position within the threaded ends 13 and 18 of the tapered sleeve 12. Again, further punchings can be uniformly distributed about the periphery of the sleeve 12, with two such punchings being shown in the embodiment of FIGS. 3 and 8.

The forming support 10 illustrated in FIG. 7 is used in a manner similar to that described in conjunction with the she-bolt embodiment. In particular, except for the depressions 16 formed in the sleeve 12 during the punching or pressing process, the remainder of the sleeve is disposed between concrete-retaining members, with the two secured tie rods 15 and 20 then extending beyond the retaining members and being appropriately secured to the retaining members.

At the conclusion of the concrete pouring process, the entire forming support 10, namely the sleeve 12 and the two secured tie rods 15 and 20, can be removed from the poured wall. To facilitate the removal process, the end 22 of the tie rod 20 that is threaded into the narrower end 18 of the sleeve 12 is tapped or hammered upon to loosen the forming support, and again in particular the sleeve 12 thereof, from the poured concrete. To avoid damage to the remaining threads of the tie rod 20, the end 22 thereof that is tapped or hammered upon can have the threads removed therefrom, as can be seen in the illustration of FIG. 7. The remainder of the removal process is comparable to that described above. In particular, after the threaded tie rod 15 has been threaded out of its retaining member, the forming support can be pulled out of the poured concrete, which once again is made possible due to the tapered nature of the sleeve 12.

As will be appreciated by those of skill in the art, the threaded tie rods 15 and 20 are in the form of known “rebar” which is provided with a helical thread for mating with the helical threads of the internal threads 14 and 19 provided at least at the ends 13 and 18 of the tapered sleeve 12. In addition, the tie rods 15 and 20 are preferably not threaded all the way around, but rather have flattened sides disposed diametrically across from one another. Such flattening on at least one side of the tie rods precludes concrete from building up in, and hence clogging, the threads of the rebar.

The sleeve 12 of the forming support 10 of the present application is preferably made of high grade industrial steel, such as St 52-3, or any other suitable durable material. In addition, the sleeve can have different lengths depending upon the application, as is also true of the tie rods 15 and 20. In addition, the punch head of the conical press can, for example, be made of hardened alloy steel.

In the embodiments described above, the means for securing the tie rods 15 and 20 in position in their respective internal threads 14 and 19 of the ends 13 and 18 of the tapered sleeve 12 has been described as being effected by a conical press to punch or press a portion of the wall of the sleeve 12 onto the outer surfaces of the tie rods between threads thereof. It is to be understood that alternative means of securement could also be utilized. By way of example only, such alternative means could be in the form of a set screw that is threaded through an appropriate threaded bore in the sleeve 12 to engage the outer surfaces of the tie rods between threads thereof. Of course, any such set screw must either be recessed within the wall of the sleeve 12, or must be flush with the exterior surface of the sleeve.

The present invention is, of course, in no way restricted to the specific disclosure of the specification and drawings, but also encompasses any modifications within the scope of the appended claims.

We claim:

1. A removable forming support, comprising:
a tapered sleeve having a first, internally threaded end and a second end, wherein said second end of said tapered sleeve has a smaller outside diameter than does said first end of said tapered sleeve;
a threaded tie rod configured to be threadedly received in said first end of said tapered sleeve; and
means for securing said tie rod in position in said first end of said tapered sleeve.

2. A forming support according to claim 1, wherein said second end of said tapered sleeve is also internally threaded.

3. A forming support according to claim 2, wherein a further tie rod is configured to be threadedly received in said second end of said tapered sleeve.

4. A forming support according to claim 3, wherein said further tie rod is also secured in position in said second end of said tapered sleeve.

5. A forming support according to claim 3, wherein said further tie rod is not secured in position in said second end of said tapered sleeve.

6. A forming support according to claim 5, wherein said internal threads formed by said internally threaded ends of said tapered sleeve do not extend all the way through said tapered sleeve, forming a solid portion in the form of a stop within said tapered sleeve for said tie rods.

7. A forming support according to claim 1, wherein said tapered sleeve is made of high grade industrial steel.

8. A forming support according to claim 1, wherein said means for securing said tie rod in position is a punched or pressed portion effected by a punching on an external surface of said tapered sleeve to form a projection on an internal surface of said tapered sleeve that extends between threads of said tie rod.

9. A forming support according to claim 2, wherein an end of said further tie rod remote from said tapered sleeve has no threads.

10. A sleeve for use in a removable forming support, comprising:
a round, tapered member having a first internally threaded end and a second end, wherein said second end of said tapered member has a smaller outside diameter than does said first end, further wherein said first, threaded end of said tapered member is configured to threadedly receive a threaded tie rod, and wherein when a threaded tie rod is threadedly received in said first end of said tapered member, said tapered member is configured to secure the tie rod in position in said first, threaded end of said tapered member.

11. A sleeve according to claim 10, wherein said second end of said tapered member is also internally threaded and is configured for receiving therein a further threaded tie rod.

12. A sleeve according to claim 10, wherein said tapered member is made of high grade industrial steel.

13. A method of producing a removable forming support, including the steps of:
providing a tapered member;
internally threading at least a first end of said tapered member, wherein said first end of said tapered member has a greater outside diameter than does an opposite, second end of said tapered member;
threading a tie rod into said first end of said tapered member; and
securing said tie rod in position in said internally threaded first end of said tapered member.

14. A method according to claim 13, which includes the further step of internally threading said second end of said tapered member.

15. A method according to claim 14, which includes the further step of threading a further threaded tie rod into said second end of said tapered member.

16. A method according to claim 15, which includes the further step of securing said further tie rod in position in said internally threaded second end of said tapered member.

17. A method according to claim 14, wherein said step of internally threading said second end of said tapered member comprises internally threading said tapered member over its entire length.

18. A method according to claim 14, wherein the internal threads of said first and second ends of said tapered member do not meet one another, thus forming a solid portion or stop within said tapered member for said tie rods when such tie rods are threaded into said threaded ends of said tapered member.
